(19) United States
(12) Patent Application Publication
(10) Pub. No.: US 2026/0304428 A1
(43) Pub. Date: Oct. 1, 2026

(54) METHOD FOR PERFORMING SENSING AND COMMUNICATION IN WIRELESS COMMUNICATION SYSTEM AND APPARATUS FOR SUPPORTING THE SAME

(71) Applicant: HANBAT NATIONAL UNIVERSITY INDUSTRY-ACADEMIC COOPERATION FOUNDATION, Daejeon (KR)

(72) Inventors: Eunkyung KIM, Daejeon (KR); Gosan NOH, Daejeon (KR)

(21) Appl. No.: 19/577,838

(22) Filed: Mar. 25, 2026

(30) Foreign Application Priority Data
Mar. 26, 2025 (KR) 10-2025-0038494
Mar. 3, 2026 (KR) 10-2026-0037915

(51) Int. Cl. H04W 72/20; H04W 72/0446; H04W 72/0453; H04W 92/20

(52) U.S. Cl. CPC H04W 72/20; H04W 72/0446; H04W 72/0453; H04W 92/20

(57) ABSTRACT

The present disclosure provides a method for performing communication and sensing in a wireless communication system supporting ISAC, the method performed by a base station including transmitting a radio signal on first wireless resources allocated for the communication; performing sensing for a target object through reception of a signal on second wireless resources allocated for the sensing; and transmitting, to an adjacent base station, a control message indicating that the first wireless resources and the second wireless resources are not to be used.

### CROSS-REFERENCE TO RELATED APPLICATION

This application claims the benefit of and priority to Korean Patent Application No. 10-2025-0038494, filed on Mar. 26, 2025, and Korean Patent Application No. 10-2026-0037915, filed on Mar. 3, 2026, the entire disclosure(s) of which is hereby incorporated herein by reference in its entirety.

### TECHNICAL FIELD

The present disclosure relates to a wireless communication system, and more specifically, to a method for performing communication and sensing in a wireless communication system that supports integrated sensing and communication (ISAC).

### BACKGROUND

With the standardization of 3rd Generation Partnership Project (3GPP), high-quality mobile communication services have been realized by 5G mobile communication. Such a system needs to satisfy various requirements such as enhanced mobile broadband (eMBB), massive machine-type communication (mMTC), and ultra-reliable and low-latency communication (URLLC), and to this end, achieve a performance target in a dense user equipment environment as well as high data transmission rate, low latency, and high reliability. Further, 5G aims to expand to application services such as Internet of things (IoT), vehicle-to-everything (V2X), and non-terrestrial networks (NTN).

The ITU-R has clearly defined technical requirements for IMT-2030 in order to present a vision for 6G mobile communication. Beyond the scope of existing eMBB, mMTC, and URLLC, innovations such as immersive communication, massive communication, and hyper reliable and low-latency communication are pursued. Further, the development in various areas such as integration of sensing and communication for communication convergence services, AI and communication, and ubiquitous connectivity is aimed at.

In particular, integrated sensing and communication (ISAC), which is one of key scenarios of 6G, means integration of sensing technology and communication technology. ISAC technology plays a significant role in various application fields such as autonomous vehicles, smart cities, and Internet of Things (IoT), and contributes to enabling collection and transmission of data to be performed more efficiently.

The ISAC technology is utilized for detection of objects and intruders in various environments, and for various purposes such as collision avoidance, path tracking, vehicle driving support, public safety, environmental monitoring, and health care. For example, the ISAC technology provides a function of detecting an intruder in a smart home environment and approach of pedestrians and animals in a highway and railway section to prevent potential accidents. In a smart factory, the ISAC technology detects robots or moving bodies to contribute to improving the safety of a working environment. Further, the ISAC is applied to collision avoidance and path tracking of uncrewed aerial vehicles (UAVs), vehicles, and automated guided vehicles (AGVs), and supports a positioning function through 5G and 6G systems.

Sensing information based on 5G and 6G can be utilized to improve a behavior of a vehicle, and various types of sensor data can be integrated to provide more accurate information. The ISAC is utilized for searching for missing persons and tracking of criminal suspects, and provides head-up display (HUD) information to firefighters at a fire site to improve efficiency of rescue activities. Further, The ISAC can detect flooding due to heavy rainfall to issue a flood warning and contribute to preventing casualties in advance. The ISAC includes a function of monitoring a respiratory condition through a sleep monitoring service, checking a health condition using a 5G signal without equipment, and detecting a movement or a fall in a house. These technologies are expected to provide practical safety and efficiency in various application fields.

### SUMMARY

An object of the present disclosure is to provide an operation method for monostatic sensing in order to perform communication and sensing in an integrated sensing and communication (ISAC) system and a signal transmission and reception method.

The objects to be achieved in the present disclosure are not limited to the object mentioned above, and other objects that are not mentioned may be clearly understood by those skilled in the art to which the present disclosure pertains from the description below.

The present disclosure provides a method for performing communication and sensing in a wireless communication system supporting integrated sensing and communication (ISAC), the method performed by a base station including: transmitting a radio signal on first wireless resources allocated for the communication; performing sensing for a target object through reception of a signal on second wireless resources allocated for the sensing; and transmitting, to an adjacent base station, a control message indicating that the first wireless resources and the second wireless resources are not to be used.

Further, in the present disclosure, the control message includes at least one of configuration information related to the radio signal transmission and configuration information related to signal reception for the sensing.

Further, in the present disclosure, the configuration information includes at least one of a sensing mode identity for distinguishing between sensing modes, information on the number of target objects, information for target object distinguishment, information for distinguishing a base station performing sensing, frequency allocation information, time allocation information, bandwidth part (BWP) information, usage waveform information, information on a slot format, information on a reference signal, information on multiple antennas, and information on beamforming.

Further, in the present disclosure, the configuration information related to the radio signal transmission includes at least one of frequency allocation information and time allocation information for the first wireless resources.

Further, in the present disclosure, the configuration information related to the signal reception for the sensing includes at least one of frequency allocation information and time allocation information for the second wireless resources.

Further, in the present disclosure, the control message further includes a transmitting base station identifier for identifying a base station transmitting the control message and a receiving base station identifier for identifying a base station receiving the control message.

Further, in the present disclosure, the control message is delivered via an Xn interface or is delivered over a core network via an NG interface.

Further, in the present disclosure, the first wireless resources and the second wireless resources are the same wireless resources.

Further, the present disclosure provides a method for performing communication and sensing in a wireless communication system supporting integrated sensing and communication (ISAC), the method performed by a base station including: delivering, by a first entity of the base station, configuration information related to configuration for the communication and configuration information related to configuration for the sensing to a second entity of the base station via the F1 interface; transmitting, by the second entity of the base station, a radio signal on first wireless resources based on the configuration information; and performing, by the second entity of the base station, sensing for a target object through reception of a signal on second wireless resources based on the configuration information.

Further, in the present disclosure, the configuration information related to the configuration for the communication includes information on the first wireless resources, and the configuration information related to the configuration for the sensing includes information on the second wireless resources.

Further, in the present disclosure, the configuration information includes an entity identifier for identifying the second entity.

Further, in the present disclosure, the method performed by a base station further includes controlling, by the first entity of the base station, suspension of transmission on the first wireless resources and the second wireless resources to a second entity of the base station that does not match the entity identifier.

Further, in the present disclosure, the first wireless resources and the second wireless resources are the same wireless resources.

Further, in the present disclosure, the first wireless resources and the second wireless resources include at least one of frequency allocation information and time allocation information.

Further, in the present disclosure, the method performed by a base station further includes delivering, by the second entity of the base station, the configuration information related to configuration for the communication and the configuration information related to configuration for the sensing to a first entity of an adjacent base station via an Xn-C interface.

Further, in the present disclosure, the first entity is a central unit (CU), and the second entity is a distributed unit (DU).

Further, the present disclosure provides a wireless apparatus for performing communication and sensing in a wireless communication system supporting integrated sensing and communication (ISAC), the wireless apparatus including: a communication module configured to transmit a radio signal on first wireless resources allocated for the communication; a sensing module configured to perform sensing for a target object through reception of a signal on second wireless resources allocated for the sensing; and a processor functionally connected to the communication module and the sensing module to control an overall operation of the wireless apparatus, wherein the processor performs control for transmission of a control message indicating that the first wireless resources and the second wireless resources are not to be used to an adjacent base station.

Further, the present disclosure provides a wireless apparatus for performing communication and sensing in a wireless communication system supporting integrated sensing and communication (ISAC), the wireless apparatus including: a first entity configured to deliver configuration information related to configuration for the communication and configuration information related to configuration for the sensing to a second entity of the wireless apparatus via an F1 interface; and a second entity configured to transmit a radio signal on first wireless resources based on the configuration information and to perform sensing for a target object through reception of a signal on second wireless resources based on the configuration information.

Further, in the present disclosure, the first entity is a gNB-CU (Central Unit), and the second entity is a gNB-DU (Distributed Unit).

The method proposed in the present disclosure has an effect of enabling an integrated sensing-communication operation of a base station to be performed more stably and effectively.

The effects obtainable in the present disclosure are not limited to the effects mentioned above, and other effects that are not mentioned may be clearly understood by those skilled in the art to which the present disclosure pertains from the description below.

### BRIEF DESCRIPTION OF THE DRAWING

In order to help understanding of the present disclosure, the accompanying drawings included as a part of the detailed description provide embodiments of the present disclosure, and are used to describe technical features of the present disclosure together with the detailed description.

FIG. 1 illustrates an example of a structure of a 5G NR system to which a method proposed in the present disclosure may be applied.

FIG. 2 illustrates another example of the structure of the 5G NR system to which the method proposed in the present disclosure may be applied.

FIG. 3 illustrates examples of a sensing method in ISAC.

FIG. 4 is a diagram illustrating an example of a monostatic scheme and a bistatic scheme to which the method proposed in the present disclosure may be applied.

FIG. 5 is a diagram illustrating an example of a method for performing communication and sensing in a base station proposed in the present disclosure.

FIG. 6 is a diagram illustrating another example of the method for performing communication and sensing in the base station proposed in the present disclosure.

FIG. 7 is a flowchart illustrating an example of an operation method for a base station for performing communication and sensing proposed in the present disclosure.

FIG. 8 is a flowchart illustrating another example of the operation method for a base station for performing communication and sensing proposed in the present disclosure.

FIG. 9 is a block configuration diagram of a wireless apparatus according to an embodiment of the present disclosure.

### DETAILED DESCRIPTION

The technical terms used in the present disclosure are merely used to describe specific embodiments, and it should be noted that there is no intention to limit the spirit of the technology disclosed in the present disclosure. Further, unless the technical terms used in the present disclosure are particularly defined as having other meanings in the present disclosure, the technical terms should be construed as having meanings generally understood by those skilled in the art to which the technology disclosed in the present disclosure pertains, and should not be construed as having excessively comprehensive meanings or excessively reduced meanings. Further, when a technical term used in the present disclosure is an incorrect technical term that fails to accurately express the spirit of the technology disclosed in the present disclosure, the term should be replaced and understood with a technical term that can be correctly understood by those skilled in the art to which the technology disclosed in the present disclosure pertains. Further, general terms used in the present disclosure should be construed according to what is defined in dictionaries or according to contexts and should not be construed as having excessively reduced meanings.

Terms including ordinals such as first and second used in the present disclosure may be used to describe various components, but the components should not be limited by the terms. The terms are only used for the purpose of distinguishing one component from another component. For example, a first component may be named as a second component without departing from the scope of rights of the present disclosure, and similarly a second component may also be named as a first component.

Hereinafter, embodiments disclosed in the present disclosure will be described in detail with reference to the accompanying drawings, and the same or similar components are denoted by the same reference numerals regardless of the drawings and redundant descriptions thereof will be omitted.

Further, when it is determined that detailed description of related known technology may obscure the gist of the technology disclosed in the present disclosure in describing the technology disclosed in the present disclosure, the detailed description will be omitted. Further, it should be noted that the accompanying drawings are only provided to facilitate understanding the spirit of the technology disclosed in the present disclosure, and the spirit of the technology should not be construed as being limited by the accompanying drawings.

Among terms used in the present disclosure, “configuration” may be referred to as “operation,” “proposal,” “indication,” or the like, “transmission and reception” may be referred to as “Tx/Rx,” “transmission and reception,” or the like, and “A/B” may be construed as “at least one of A or B.”

The terms, concepts, procedures, and the like used in the present disclosure are briefly summarized as follows.

(1) Definition of terms
Sensing gNB: A sensing gNB is a base station having a sensing signal transmission and reception function.
Sensing CN: A sensing CN is a logical function of performing a sensing function (SF) in a core network.
One sensing gNB may include one or more sensing TRPs to perform a role as a transmission point or a reception point for a sensing signal.

(2) Sensing service procedure between a RAN and core network (CN): This may include a flow in which the sensing function (SF) in the core network instructs the sensing gNB of the RAN to perform a sensing task through a sensing request, and the sensing gNB performs environment sensing according to a corresponding resource configuration (or a sensing-related resource configuration) and then delivers a sensing result report to the core network.
When a sensing service request occurs in the core network, the SF discovers and selects a corresponding sensing gNB, sets a sensing session with the discovered sensing gNB, and delivers sensing configuration information to the sensing gNB.
The sensing gNB performs a sensing operation such as transmitting a target signal according to the received sensing configuration information and receiving reflected waves, and reports sensing results (for example, whether an object exists, or location information) processed from measured data to the SF.
The SF delivers a final sensing result to an upper service through additional post-processing if necessary.

(3) Distinguishment between a control plane and a user plane: Sensing control signals (for example, sensing session request/setting, and termination instruction) are processed with a control plane (CP) message for reliability and interworking, and the control plane or the user plane may be used for delivery of sensing data (report).

(4) Sensing resource management and TRP selection: When a sensing service is performed, a determination as to which TRP to utilize for transmission and reception may be performed by a gNB.

(5) Sensing data processing location: There is a need to define where to perform processing after reception of a sensing signal.
A primary processing function for the sensing data (for example, basic signal processing such as matched filtering, FFT, and peak detection, and object detection computation) may be placed at a gNB side such that only result information is transmitted to the core network.
Further, a model for integrated processing in the SF of the core network is conceivable. In this case, sensing data of several gNBs may be fused or a more complex algorithm may be applied.

The method proposed in the present disclosure may be applied to a user equipment, a base station, a radio access network (RAN), a core network, or the like of a wireless communication system based on 3GPP 5G NR or 6G in order to satisfy requirements for the ISAC. However, the method proposed in the present disclosure is not limited thereto, and is also applicable to other wireless communication systems based on long term evolution (LTE) or Institute of Electrical and Electronics Engineers (IEEE) 802 technology.

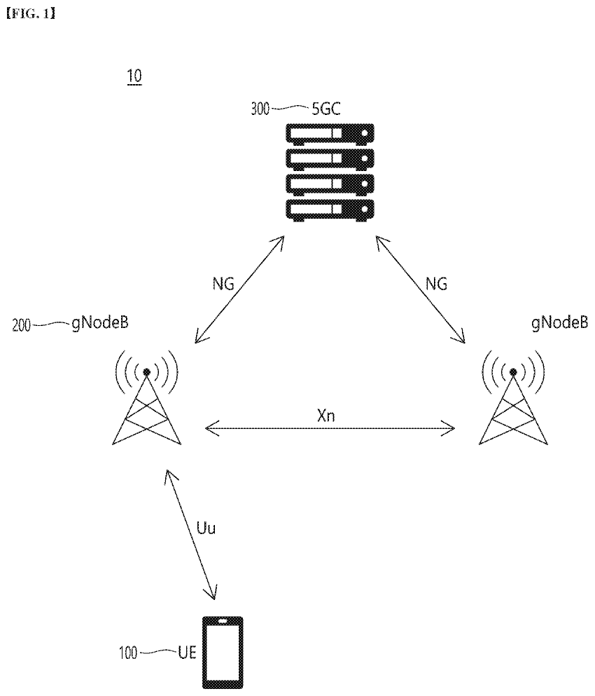

FIG. 1 illustrates an example of a structure of a 5G NR system to which the method proposed in the present disclosure may be applied.

Referring to FIG. 1, a radio access network of a 5G NR system (or a wireless communication system) 10 may include a user equipment 100, at least one base station 200, at least one core network 300, and the like.

The base station may include a gNodeB, an eNodeB, a transmission reception point (TRP), and the like. Between gNodeBs, connection may be made via the Xn interface.

The core network includes a 5G core network (5GC). The 5GC may be connected with a gNodeB via an NG interface, and between the gNodeB and a user equipment (UE), connection is made through a Uu interface in a wireless section.

The 5GC may support a service-oriented architecture, and may satisfy various network requirements by providing resources and services virtually separated through network slicing. Further, flexible utilization and distributed characteristics of network resources are realized through separation of the control plane (CP) and the user plane (UP). The 5GC may support the following functions:
Access and mobility management function (AMF): This is in charge of access and mobility management, user equipment authentication processing, and the like.
Session management function (SMF): Session management and IP address allocation are performed.
User plane function (UPF): This performs packet routing, forwarding, inspection, quality of service (QoS) processing, packet filtering, traffic measurement, and the like for user data processing, and serves as a gateway between the RAN and the Internet.
Network repository function (NRF): This performs search and registration management of network functions, and service discovery.
Policy control function (PCF): This serves to control policy management, QoS, and charging policies.

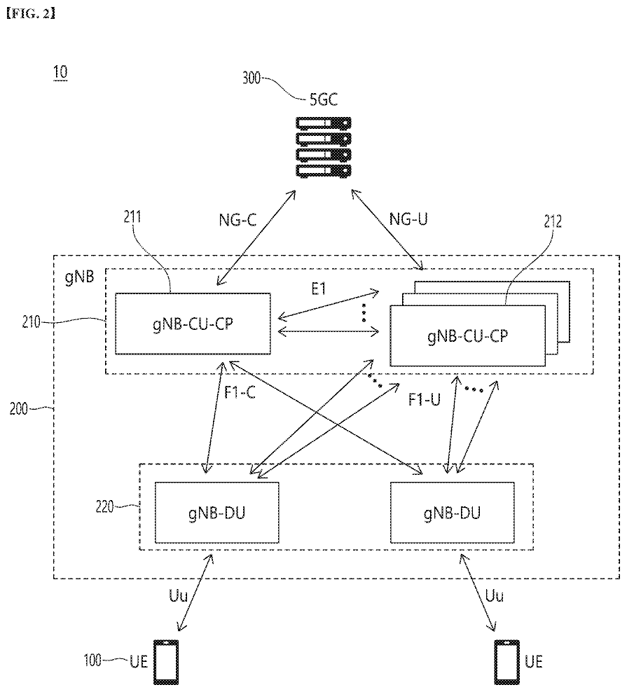

FIG. 2 illustrates another example of the structure of the 5G NR system to which the method proposed in the present disclosure may be applied.

As illustrated in FIG. 2, a gNodeB (or gNB) may include a central unit (CU) 210 and a distributed unit (DU) 220, and is generally designed to divide and perform operations of an L2 protocol. That is, the gNB may be separated into a gNB-CU and a gNB-DU. For example, the gNB-CU may include radio resource control (RRC), service data adaptation protocol (SDAP), and packet data convergence protocol (PDCP) layers, and the gNB-DU may include radio link control (RLC), medium access control (MAC), and physical (PHY) layers. Further, the gNB-CU may include a gNB-CU-CP 211 that performs a control plane function and a gNB-CU-UP 212 that performs a user plane function.

In the gNB, one gNB-CU-CP may be logically connected with a plurality of gNB-CU-UPs via an E1 interface, and one gNB-CU-CP is connected with several gNB-DUs via a F1-C interface. Further, several gNB-CU-UPs may be connected with a plurality of gNB-DUs through an F1-U interface. One gNB-DU is connected with one gNB-CU-CP, and one gNB-CU-UP may be connected with one gNB-CU-CP.

Interfaces between network nodes constituting each radio access network perform the following functions:
NG interface: This includes paging, user equipment context management, mobility management, protocol data unit (PDU) session management, non-access stratum (NAS) transmission, NAS node selection, NG interface management, alert message transmission, configuration delivery, access and mobility management function (AMF) management, AMF load balancing, location reporting, AMF relocation, radio capability management of a user equipment, and the like.
Xn interface: An Xn-C interface responsible for the control plane performs various functions such as Xn interface management, error processing, user equipment mobility management, dual connectivity, energy saving, and resource coordination, and an Xn-U interface responsible for the user plane serves as data transmission, flow control, provision of assistance information, high-speed retransmission, and the like.
F1 interface: An F1-C interface for processing a control plane performs functions such as F1 interface management, system information management, F1 user equipment context management, RRC message transmission, paging, alert message information delivery, and the F1-U interface responsible for a user plane performs functions such as user data transmission and flow control.
E1 interface: The E1 interface performs functions such as E1 management, E1 bearer context management, tracking, load management, and measurement result delivery.

Next, an ISAC operation applicable to a radio access network will be described with reference to related drawings.

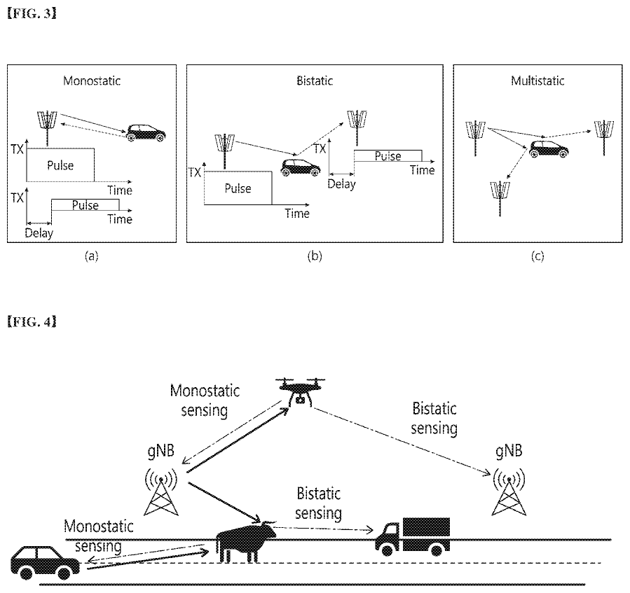

FIG. 3 illustrates examples of a sensing method in the ISAC. Specifically, FIG. 3a illustrates a monostatic scheme, FIG. 3b illustrates a bistatic scheme, and FIG. 3c illustrates a multistatic scheme.

The monostatic scheme of FIG. 3a is a scheme in which a transmission and reception node 1 and a transmission and reception node 2 exist at the same location or in the same apparatus and perform sensing through transmission and reception by themselves. The bistatic scheme of FIG. 3b is a scheme in which the transmission and reception node 1 and the transmission and reception node 2 exist at different locations or apparatuses and perform sensing through mutual transmission and reception. For example, the bistatic scheme may include sensing between a base station 1 and a base station 2, between RRHs connected to base stations, between a base station and a wired/wireless relay, between a user equipment and a base station, between the user equipment and the RRH, or between other communication nodes. The multistatic scheme of FIG. 3c is a scheme for performing sensing through three or more transmission and reception nodes installed at different locations or apparatuses, and includes simultaneous or sequential operation among a plurality of nodes, a cooperative and distributed sensing scheme, and modified schemes equivalent thereto.

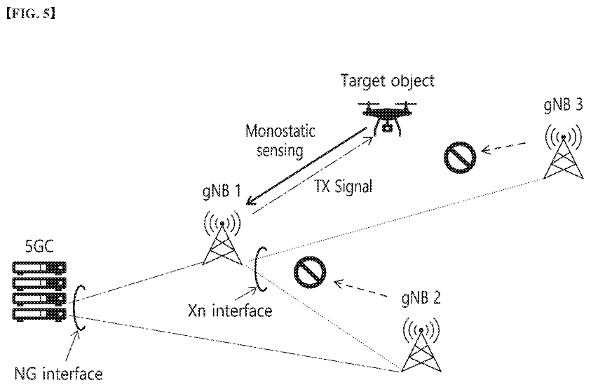

Next, The ISAC operation applicable to the radio access network will be described with reference to related drawings. When a 5G NR or 6G communication network is used for the purpose of object sensing, various scenarios as illustrated in FIG. 4 may be included. As described in FIG. 3, classification into a monostatic scheme and a bistatic scheme may be made depending on whether a transmitter and a receiver are operated at the same location. In the monostatic scheme, the transmitter and the receiver operate at the same point, and a sensing task is performed through this scheme in a base station or a user equipment. On the other hand, in the bistatic scheme, the transmitter and the receiver operate at different locations, and a bistatic sensing scheme between base stations, between a user equipment and a user equipment, or between the base station and the user equipment may be defined. Examples of the monostatic scheme and the bistatic scheme are as follows and illustrated in FIG. 4. FIG. 4 is a diagram illustrating an example of a monostatic scheme and a bistatic scheme to which the method proposed in the present disclosure may be applied.
Base station monostatic sensing: A process in which a radio signal transmitted from a specific base station is reflected by a target object, and a reflected signal is received again by the base station is sensed.

User equipment monostatic sensing: A process in which a radio signal transmitted from a specific user equipment is reflected by a target object, and a reflected signal is received again by the user equipment is sensed.

Base station-to-base station bistatic sensing: A process in which a radio signal transmitted from a specific base station is reflected by a target object, and then a reflected signal is received by another base station is sensed.

Base station-to-user equipment bistatic sensing: A process in which a radio signal transmitted from a specific base station is reflected by a target object, and a reflected signal is received by another user equipment is sensed.

User equipment-to-base station bistatic sensing: A process in which a radio signal transmitted from a specific user equipment is reflected by a target object, and a reflected signal is received by another base station is sensed.

User equipment-to-user equipment bistatic sensing: A radio signal transmitted from a specific user equipment is reflected by a target object, and a reflected signal is received by another user equipment is sensed.

In a sensing process using the ISAC, Measurement may be performed through an amount of a signal reflected from a target object, that is, a radar cross section (RCS), and this value is related to various elements such as a size, material, shape, and direction of the object.

Meanwhile, in the operation of the ISAC, interference may occur due to a sensing task and a communication task being simultaneously performed compared with a sensing-only system or a communication-only system. Such interference is classified into various types as follows.
Self interference: This is interference occurring in a process of receiving a signal for sensing while transmitting a communication signal. Such self interference may be caused by external reflected waves, or may be caused by power leakage in an antenna or an RF circuit inside a transceiver. Strength of the self interference is relatively much larger than strength of a received signal.
Mutual interference: This is interference occurring when a communication signal and a sensing signal share a time or a frequency band. In this case, communication performance or sensing performance may be degraded depending on relative strengths of the two signals.
Clutter: The sensing performance may be degraded due to clutter existing in a surrounding environment, in addition to the target object. The clutter may be classified into static clutter at a fixed location and non-static clutter that is movable.

Hereinafter, a monostatic sensing method proposed in the present disclosure will be described.

A base station operation for monostatic sensing may include a series of operations in which a specific base station transmits a radio signal for sensing and receives a radio signal reflected from a target object to perform sensing. In this case, the base station may perform configuration for radio signal transmission and configuration for sensing signal reception.

Examples of information that may be included in the configuration for radio signal transmission may include a sensing mode identity (ID), the number of target objects, a target object identifier, a transmitting base station identifier, a sensing base station identifier, frequency allocation information, time allocation information, bandwidth part (BWP) information, usage waveform information, a slot format, reference signal information, multiple antenna information, beamforming information, and the like.

Meanwhile, examples of information that may be included in the configuration for sensing signal reception include the sensing mode identity, the number of target objects, the target object identifier, the transmitting base station identifier, the sensing base station identifier, the frequency allocation information, the time allocation information, the BWP information, the usage waveform information, the slot format, the reference signal information, the multiple antenna information, the beamforming information, and the like.

The sensing mode identity may include monostatic sensing, bistatic sensing, and the like. Additionally, the sensing mode identity may include base station monostatic sensing, user equipment monostatic sensing, base station-to-base station bistatic sensing, base station-to-user equipment bistatic sensing, user equipment-to-base station bistatic sensing, user equipment-to-user equipment bistatic sensing, or the like.

The usage waveform information may include, for example, orthogonal frequency-division multiplexing (OFDM) or discrete frequency transform-spread-OFDM (DFT-s-OFDM).

The slot format may include arrangement information for downlink, uplink, sidelink, flexible sections, or the like in a slot, and may include a slot format index for a plurality of predetermined slot format candidates.

The information on multiple antennas may include the number of layers for multiple antenna transmission, the number of antennas, or the like. Further, the beamforming information may include the number of beams, a beam identity, or the like.

Next, a base station operation and signal delivery method for monostatic sensing proposed in the present disclosure will be described.

That is, in the method proposed in the present disclosure, the base station may include a step (step (1)) of transmitting a radio signal and a step (step (2)) of receiving a reflected wave from a target object (or sensing target) and sensing the target object. In the step (step (1)) of transmitting the radio signal, the base station may select at least one of specific frequency resources, time resources, and beam resources for signal transmission and object sensing. Further, the base station may perform an operation of receiving the reflected wave and sensing the target object by using at least selected one of the specific frequency resources, time resources, and beam resources.

Meanwhile, in a step (step (2)) in which the base station receives the reflected wave and senses the target object, target object sensing performance may be degraded due to an interference signal transmitted from a neighboring base station. In order to solve this problem, as illustrated in FIG. 5, a base station gNB 1 performing radio signal transmission (or communication) and target object sensing may deliver, to an adjacent base station gNB 2 or gNB 3 (or neighboring base station), a control message indicating that wireless resources configured for radio signal transmission and target object sensing are not to be used while performing the corresponding operation (or communication and sensing operations). The control message may include configuration values (or configuration information) for the radio signal transmission and/or configuration values (or configuration information) for sensing signal reception. FIG. 5 is a diagram illustrating an example of a method for performing communication and sensing in a base station proposed in the present disclosure.

More specifically, an adjacent base station (gNB 2 or gNB 3) may use a scheme for suspending transmission using a corresponding frequency band by using frequency allocation information among the configuration values for radio signal transmission and/or configuration values for sensing signal reception included in the control message. As another embodiment, the adjacent base station may use a scheme of suspending transmission during a time allocated to a corresponding frequency band by using frequency allocation information and time allocation information among the configuration values for radio signal transmission or the configuration values for sensing signal reception.

As an embodiment for delivery of the control message for suspending transmission operation of the adjacent base station, a message may be delivered between base stations via the Xn interface. That is, the base station gNB 1 may deliver the control message to the adjacent base station through the Xn interface.

The base station gNB 1 performing transmission (or communication) and sensing operations delivers the control message through a predefined message identifier, and the control message may include a message transmission base station identifier and a message reception base station identifier. Further, the base station gNB 1 may transmit configuration values including the frequency allocation information and/or time allocation information, which are included in the control message. The adjacent base station that has received the control message may use a scheme of suspending transmission with respect to the frequency and/or time allocation resource region based on the received control message.

As another embodiment for the delivery of the control message for suspending the transmission operation of the adjacent base station, the base station gNB 1 performing transmission (or communication) and sensing operations via the NG interface may use a scheme of delivering the control message including the frequency allocation information and/or time allocation information to the adjacent base station over a core network (for example, 5GC) via the NG interface, such that the adjacent base station suspends the transmission with respect to the frequency and/or time allocation resource region based on the received control message.

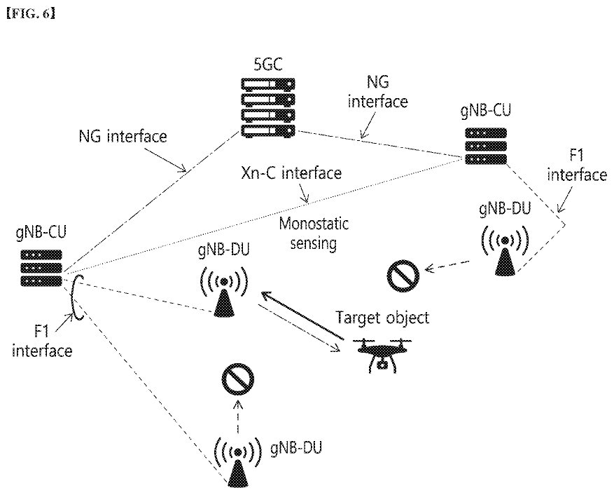

FIG. 6 is a diagram illustrating another example of the method for performing communication and sensing in a base station proposed in the present disclosure.

Referring to FIG. 6, the base station operation and signal delivery method for monostatic sensing proposed in the present disclosure may be applied even in an environment in which the base station is separated into a gNB-CU and a gNB-DU. In order to perform signal transmission (or communication) and object sensing operations, the gNB-CU of the base station performs configuration for radio signal transmission and configuration for sensing signal reception, and transmit corresponding information (or the configuration information) and data to a gNB-DU connected to the gNB-CU through the F1 interface.

In this case, the configuration values for radio signal transmission and the configuration values for sensing signal reception may include a gNB-DU identifier for performing radio signal transmission and object sensing. A gNB-DU matching the gNB-DU identifier may perform operations for configuration and signal generation and transmit the radio signal for sensing. Thereafter, the gNB-DU matching the gNB-DU identifier may perform a sensing operation for the target object.

Meanwhile, a gNB-DU that does not match the gNB-DU identifier may suspend transmission with respect to frequency and/or time allocation resource regions among the configuration for radio signal transmission and the configuration for sensing signal reception, and whether to suspend the transmission may be controlled by the gNB-CU.

Meanwhile, the configuration values for transmission and the configuration values for sensing signal reception may also be delivered to a gNB-CU and a gNB-DU included in an adjacent base station other than a base station gNB 1 for performing signal transmission and object sensing operations, in order to prevent interference during object sensing, such that transmission can be suspended with respect to a corresponding frequency and/or time allocation resource region. The configuration values (the configuration values for transmission and the configuration values for sensing signal reception) may be delivered to the gNB-CU of the adjacent base station via the Xn-C interface and subsequently delivered to the gNB-DU of the adjacent base station via the F1 interface.

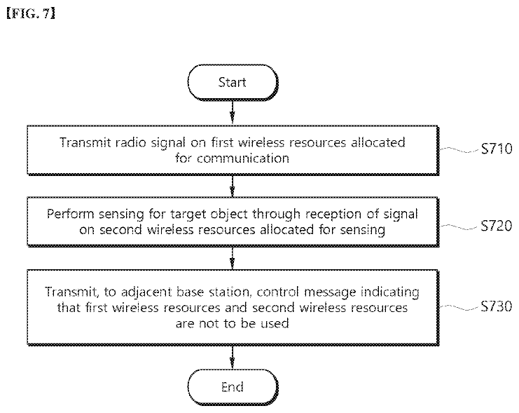

FIG. 7 is a flowchart illustrating an example of an operation method for a base station for performing communication and sensing proposed in the present disclosure.

First, the base station transmits a radio signal on first wireless resources allocated for communication (S710).

The base station performs sensing for the target object through reception of a signal on second wireless resources allocated for sensing (S720).

The first wireless resources and the second wireless resources may be the same wireless resources, and may be multiplexed.

The base station transmits, to an adjacent base station, a control message indicating that the first wireless resources and the second wireless resources are not to be used (S730).

Step S730 may be performed before step S720 or S710.

The control message may include at least one of configuration information related to the radio signal transmission and configuration information related to the signal reception for sensing.

The configuration information may include at least one of a sensing mode identity for distinguishing between sensing modes, information on the number of target objects, information for target object distinguishment, information for distinguishing a base station performing sensing, frequency allocation information, time allocation information, bandwidth part (BWP) information, usage waveform information, information on a slot format, information on a reference signal, information on multiple antennas, and information on beamforming.

The configuration information related to radio signal transmission may include at least one of frequency allocation information and time allocation information for the first wireless resources, and the configuration information related to signal reception for sensing may include at least one of frequency allocation information and time allocation information for the second wireless resources.

Further, the control message may further include the transmitting base station identifier for identifying a base station transmitting the control message, and the receiving base station identifier for identifying a base station receiving the control message.

Further, the control message may be delivered via the Xn interface or may be delivered over a core network via the NG interface.

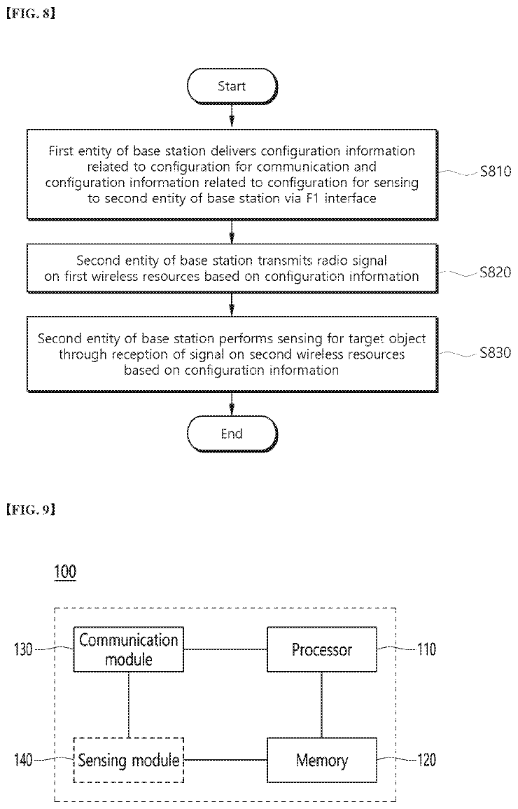

FIG. 8 is a flowchart illustrating another example of the operation method for a base station for performing communication and sensing proposed in the present disclosure.

A first entity of the base station delivers configuration information related to configuration for communication and configuration information related to configuration for sensing to a second entity of the base station via the F1 interface (S810). Here, the first entity may be a central unit (CU), and the second entity may be a distributed unit (DU).

The configuration information related to configuration for communication may include information on the first wireless resources, and the configuration information related to configuration for sensing may include information on the second wireless resources.

Further, the configuration information may include an entity identifier identifying the second entity.

The first entity of the base station may control suspension of transmission on the first wireless resources and the second wireless resources with respect to a second entity of the base station that does not match the entity identifier.

The first wireless resources and the second wireless resources may be the same wireless resources or may be multiplexed.

Further, the first wireless resources and the second wireless resources may include at least one of frequency allocation information and time allocation information.

The second entity of the base station transmits a radio signal on the first wireless resources based on the configuration information (S820).

The second entity of the base station performs sensing for the target object through reception of a signal on the second wireless resources based on the configuration information (S830).

Additionally, the second entity of the base station may deliver the configuration information related to configuration for communication and the configuration information related to configuration for sensing to a first entity of the adjacent base station via the Xn-C interface.

FIG. 9 is a block configuration diagram of a wireless apparatus according to one embodiment of the present disclosure.

A wireless apparatus 100 may be a core network (CN), a base station, a user equipment, or the like.

The wireless apparatus may include a processor 110, a memory 120, a communication module 130, a sensing module 140, and the like.

The processor implements the functions, processes, and/or methods proposed in FIGS. 1 to 8 above. Layers of wired/wireless interface protocols may be implemented by the processor. The memory is connected to the processor to store various types of information for driving the processor. The communication module is connected to the processor to transmit and/or receive wired/radio signals.

The communication module may include an antenna for transmitting/receiving a radio signal.

The sensing module may be included only in a wireless apparatus that performs sensing, and may not be included in a wireless apparatus that does not perform sensing.

The embodiments described above are those in which components and features of the present disclosure are combined in a predetermined form. Each component or feature should be considered optional unless explicitly stated otherwise. Each component or feature may be embodied in a form in which the component or feature is not combined with other components or features. Further, it is also possible to configure an embodiment of the present disclosure by combining some components and/or features. Order of operations described in the embodiments of the present disclosure may be changed. Some configurations or features of an embodiment may be included in another embodiment or replaced with corresponding configurations or features of the other embodiment. It is obvious that embodiments can be configured by combining claims that do not have an explicit citation relationship in the claims, or can be included as new claims by amendment after filing.

An embodiment according to the present disclosure may be implemented by various means, such as hardware, firmware, software, or a combination thereof. When the embodiment of the present disclosure is implemented by the hardware, the embodiment may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When the embodiment of the present disclosure is implemented by the firmware or software, the embodiment of the present disclosure may be implemented in the form of, for example, modules, procedures, or functions of performing the functions or operations described above. Software code may be stored in a memory and driven by a processor. The memory may be located inside or outside the processor to exchange data with the processor by various means already known.

It is obvious to those skilled in the art that the present disclosure can be embodied in other specific forms without departing from essential features of the present disclosure. Therefore, the above detailed description should not be construed as being restrictive in all respects and should be considered as being illustrative. The scope of the present disclosure should be determined by reasonable interpretation of the appended claims, and all changes within an equivalent scope of the present disclosure are included in the scope of the present disclosure.

What is claimed is:

1. A method performed by a base station for performing communication and sensing in a wireless communication system supporting integrated sensing and communication (ISAC), the method comprising:
transmitting, using first wireless resources allocated for the communication, a radio signal;
receiving, using second wireless resources allocated for the sensing, a signal;
performing, based on the received signal, sensing for a target object; and
transmitting, to an adjacent base station, a control message indicating suspension of use of the first wireless resources and the second wireless resources.

2. The method of claim 1, wherein the control message comprises at least one of:
configuration information related to transmission of the radio signal, or
configuration information related to reception of the signal for the sensing.

3. The method of claim 2, wherein the configuration information related to the transmission of the radio signal and the configuration information related to the reception of the signal comprise at least one of:
a sensing mode identity for distinguishing between sensing modes,
information on a number of target objects,
information for target object distinguishment,
information for distinguishing a base station performing sensing,
frequency allocation information,
time allocation information,
bandwidth part (BWP) information,
waveform information,
information on a slot format,
information on a reference signal,
information on multiple antennas, or
information on beamforming.

4. The method of claim 3, wherein the configuration information related to the transmission of the radio signal comprises at least one of:
frequency allocation information for the first wireless resources, or
time allocation information for the first wireless resources.

5. The method of claim 3, wherein the configuration information related to the reception of the signal comprises at least one of:
frequency allocation information for the second wireless resources, or
time allocation information for the second wireless resources.

6. The method of claim 1, wherein the control message comprises:
a first identifier for identifying a base station transmitting the control message, and
a second identifier for identifying a base station receiving the control message.

7. The method of claim 1, wherein the transmitting of the control message to the adjacent base station comprises transmitting the control message via at least one of an Xn interface or over a core network via an NG interface.

8. The method of claim 1, wherein the first wireless resources and the second wireless resources are configured to be same wireless resources.

9. A method performed by a base station for performing communication and sensing in a wireless communication system supporting integrated sensing and communication (ISAC), the method comprising:
transmitting, by a first entity of the base station and via an F1 interface, configuration information to a second entity of the base station, wherein the configuration information comprises:
communication configuration information for the communication, and
sensing configuration information for the sensing;
transmitting, by the second entity of the base station and using first wireless resources, a radio signal, wherein the first wireless resources are allocated based on the configuration information;
receiving, by the second entity of the base station and using second wireless resources, a signal, wherein the second wireless resources are allocated based on the configuration information; and
performing, by the second entity of the base station and based on the received signal, sensing for a target object.

10. The method of claim 9, wherein:
the communication configuration information comprises information on the first wireless resources, and
the sensing configuration information comprises information on the second wireless resources.

11. The method of claim 10, wherein the configuration information comprises an entity identifier for identifying the second entity.

12. The method of claim 11, further comprising:
controlling, by the first entity of the base station, a second entity of the base station that does not correspond to the entity identifier to suspend transmission using the first wireless resources and the second wireless resources.

13. The method of claim 9, wherein the first wireless resources and the second wireless resources are configured to be same wireless resources.

14. The method of claim 9, wherein the first wireless resources and the second wireless resources comprise at least one of frequency allocation information or time allocation information.

15. The method of claim 9, further comprising:
transmitting, by the second entity of the base station and via an Xn-C interface, the configuration information to a first entity of an adjacent base station.

16. The method of claim 9, wherein:
the first entity comprises a central unit (CU), and
the second entity comprises a distributed unit (DU).

17. A wireless apparatus for performing communication and sensing in a wireless communication system supporting integrated sensing and communication (ISAC), the wireless apparatus comprising:
a communication interface configured to:
transmit, using first wireless resources allocated for the communication, a radio signal, and
receive, using second wireless resources allocated for the sensing, a signal;
a sensor configured to perform, based on the received signal, sensing for a target object; and
a processor circuit configured to transmit, to an adjacent base station, a control message indicating suspension of use of the first wireless resources and the second wireless resources.

18. The wireless apparatus of claim 17, wherein the control message comprises at least one of:
configuration information related to transmission of the radio signal, or
configuration information related to reception of the signal for the sensing.

19. The wireless apparatus of claim 18, wherein the configuration information related to the transmission of the radio signal comprises at least one of:
frequency allocation information for the first wireless resources, or
time allocation information for the first wireless resources.

20. The wireless apparatus of claim 17, wherein the first wireless resources and the second wireless resources are configured to be same wireless resources.
